(19) United States
(12) Patent Application Publication
(10) Pub. No.: US 2009/0100925 A1
(43) Pub. Date: Apr. 23, 2009

(54) SYSTEM AND METHOD FOR COATING FLEXURAL MECHANICAL RESONATORS

(75) Inventors: ROCCO DIFOGGIO, Houston, TX (US); Peter W. Reittinger, Katy, TX (US); Sebastian Csutak, Houston, TX (US)

Correspondence Address: Michael Roebuck, P.C., 6750 WEST LOOP SOUTH, SUITE 920, Houston, TX, 77401, US

(73) Assignee: Baker Hughes Incorporated, Houston, TX (US)

(21) Appl. No.: 12/244,164

(22) Filed: Oct. 2, 2008

Related U.S. Application Data
(63) Continuation-in-part of application No. 11/588,827, filed on Oct. 27, 2006, now Pat. No. 7,421,892.

(51) Int. Cl. G01N 29/34

(52) U.S. Cl. 73/32 A

(57) ABSTRACT

An illustrative embodiment is disclosed, including but not limited to an apparatus for estimating a property of a fluid downhole, including but not limited to a piezoelectric flexural mechanical resonator disposed in the fluid downhole; an electrode embedded in the piezoelectric flexural mechanical resonator; and a substantially transparent conductive coating covering the piezoelectric flexural mechanical resonator. A method is disclosed for estimating a property of a fluid downhole, the method including but not limited to embedding an electrode in a piezoelectric flexural mechanical resonator; coating the piezoelectric flexural mechanical resonator with a substantially transparent conductive coating; and disposing a piezoelectric flexural mechanical resonator disposed in the fluid downhole.

### CROSS REFERENCE TO RELATED APPLICATIONS

This patent application is a Continuation in Part of U.S. patent application Ser. No. 11/588,827 filed on Oct. 27, 2006, which claims priority to U.S. patent application Ser. No. 11/092,016 filed on Mar. 29, 2005, which claims priority to U.S. patent application Ser. No. 10/144,965 filed on May 14, 2002 which issued as U.S. Pat. No. 6,938,470 B2 and which claims priority from U.S. Provisional Patent Application Ser. No. 60/291,136 filed on May 15, 2001, all of which are hereby incorporated by reference in their entirety.

### FIELD OF THE INVENTION

The present invention relates to the field of downhole fluid analysis in hydrocarbon producing wells. More particularly, the present invention relates to a system and method for coating flexural mechanical resonators.

### RELATED ART

There is considerable interest in obtaining density and viscosity for formation fluids downhole at reservoir conditions of extreme temperature and pressure during formation sampling, production or drilling. Numerous technologies have been employed toward the end of measuring density and viscosity of liquids downhole.

### SUMMARY OF THE DISCLOSURE

In a particular illustrative embodiment a system and method for estimating a property of a downhole fluid is disclosed. The system and method include but are not limited to a coated flexural resonator disposed in the downhole fluid.

### BRIEF DESCRIPTION OF THE DRAWINGS

FIG. 1 is a depiction of front view of an illustrative embodiment of a coated resonator;

FIG. 2 is a depiction of an exploded view of an illustrative embodiment of a coated resonator;

FIG. 3 is a depiction of side view of an illustrative embodiment of a coated resonator;

FIG. 4 is a depiction of an illustrative embodiment of a coated resonator;

FIG. 5 is an illustration of a model for an equivalent circuit for a piezoelectric resonator complex impedance in a liquid environment;

FIG. 6 is an illustration of an exciter for a piezoelectric generator in an illustrative embodiment;

FIG. 7 is an illustration of a flowchart depicting a method for estimating a property of a downhole fluid;

FIG. 8 is a schematic diagram of an embodiment of the present invention deployed on a wire line in a downhole environment;

FIG. 9 is a schematic diagram of an embodiment of the present invention deployed on a drill string in a monitoring while drilling environment;

FIG. 10 is a schematic diagram of an embodiment of the present invention deployed on a flexible tubing in a downhole environment;

FIG. 11 is a schematic diagram of an embodiment of the present invention as deployed in a wireline downhole environment showing a cross section of a wireline formation tester tool; and

FIG. 12 is a schematic diagram of an embodiment of the present invention illustrating a tuning fork as deployed in a fluid flow pipe.

### DETAILED DESCRIPTION OF ILLUSTRATIVE EMBODIMENTS

The present disclosure describes an illustrative embodiment of a system and method for using a durable, tough, and peel-resistant, slightly-conductive oxide coating, such as, for example, but not limited to tin oxide—TO, or indium tin oxide—ITO. The ITO or TO coating is applied on a flexural mechanical resonator, including but not limited to a tuning fork. The tuning fork is used as sensor for determining density and viscosity of a fluid. The TO or ITO are electrically conductive ceramic films that are used instead of a conductive metal film coating. In a particular illustrative embodiment one or more electrodes are placed between plates of Lithium Niobate which form a tuning fork. The Lithium Niobate plates are placed adjacent each other, like a sandwich, so that one surface of a first tuning fork plate touches one surface of a second tuning fork plate. The exterior surfaces of the first and second tuning fork plates, that is, those surfaces except the adjacent touching surfaces of the first and second tuning fork plates are coated with TO or ITO. The sandwich configuration protects the internal metal film electrode from damage when immersed in a downhole fluid because it prevents direct fluid contact that could cause corrosion or abrasion from passing sand particles.

The surfaces of the first and second tuning fork plates that are placed adjacent one another, are placed touching each other and thus are in physical communication thereby forming a tuning fork from the two adjacent tuning fork plates. To increase the tuning fork signal by about a factor of ten, an electrically conductive coating is applied on the outside of the tuning fork to create an image charge of the embedded electrode. Previously, thin vacuum coatings of metals such as titanium or gold were used as an electrically conductive coating on the exterior of the tuning forks. However, these titanium or gold metal coatings can peel off too easily such as when, during assembly, a tuning fork is held in place with adhesive tape and the tape is subsequently removed. Gold or titanium metal film can easily peel off with the tape. The ITO conductive oxide coating is a hard, ceramic coating that sticks much better to the Lithium Niobate tuning fork surface, with is also a ceramic. The ITO coating is difficult to remove, even when subjected to scraping. Although ITO is much less conductive than metal, ITO still has more than enough conductivity to produce the small image charge that is needed to increase the tuning fork signal by up to a factor of ten. One added advantage of both TO and ITO is that they are both substantially transparent conductive coatings. Therefore, unlike metal coatings, such as titanium or gold, it is possible to see through the ITO or TO coating. Moreover, because Lithium Niobate tuning fork plates are also substantially transparent, for an ITO or TO coated fork, it is possible to see through the ITO/TO coating and Lithium Niobate plates to visually inspect the electrodes embedded between the tuning fork plates in each tine of each tuning fork and visually confirm that the electrodes are intact.

In another illustrative embodiment, an apparatus is disclosed for estimating a property of a fluid downhole including but not limited to a flexural mechanical resonator disposed in the fluid downhole; an electrode embedded in the flexural mechanical resonator; and a substantially transparent conductive coating covering the flexural mechanical resonator. In another illustrative embodiment, the apparatus further includes but is not limited to a controller in electrical communication with the electrode that actuates the flexural mechanical resonator at a frequency. In another illustrative embodiment of the apparatus, the substantially transparent conductive coating is made of ceramic. In another illustrative embodiment of the apparatus, the substantially transparent conductive coating is selected from the group consisting of indium tin oxide (ITO), tin oxide (TO), zinc oxide (ZO), or boron doped diamond (BDD). In another illustrative embodiment of the apparatus, the tuning fork further includes but is not limited to a first tuning fork plate having a first surface and a second tuning fork plate having a second surface, wherein the first surface of the first tuning fork plate is placed over a portion of the electrode and touching the second surface of the second turning fork plate. In another illustrative embodiment of the apparatus, the flexural mechanical resonator is made of Lithium Niobate. In another illustrative embodiment of the apparatus, the tuning fork and the substantially transparent conductive coating are substantially transparent thereby enabling visual inspection of the electrode embedded between a first and a second turning fork plate.

In another illustrative embodiment, a downhole tool is disclosed for estimating a property of a fluid downhole including but not limited to a flexural mechanical resonator disposed in the fluid downhole; an electrode embedded in the flexural mechanical resonator; and a substantially transparent conductive coating covering the flexural mechanical resonator. In another illustrative embodiment of the downhole tool, the downhole tool further includes but is not limited to a controller in electrical communication with the electrode that actuates the flexural mechanical resonator at a frequency. In another illustrative embodiment of the downhole tool, the substantially transparent conductive coating is made of ceramic. In another illustrative embodiment of the downhole tool, the substantially transparent conductive coating is selected from the group consisting of indium tin oxide (ITO) and tin oxide (TO). In another illustrative embodiment of the downhole tool, the tuning fork further includes but is not limited to a first tuning fork plate having a first surface and a second tuning fork plate having a second surface, wherein the first surface of the first tuning fork plate is placed over a portion of the electrode and touching the second surface of the second turning fork plate. In another illustrative embodiment of the downhole tool, the flexural mechanical resonator is made of Lithium Niobate. In another illustrative embodiment of the downhole tool, the tuning fork and the substantially transparent conductive coating are substantially transparent thereby enabling visual inspection of the electrode embedded between a first and a second turning fork plate.

In another illustrative embodiment, a method for estimating a property of a fluid downhole, the method including but not limited to embedding an electrode in a flexural mechanical resonator; coating the flexural mechanical resonator with a substantially transparent conductive coating; and disposing a flexural mechanical resonator disposed in the fluid downhole. In another illustrative embodiment of the method, the method further includes but is not limited to actuating the flexural mechanical resonator at a frequency with a controller in electrical communication with the electrode. In another illustrative embodiment of the method, the substantially transparent conductive coating is made of ceramic. In another illustrative embodiment of the method, the substantially transparent conductive coating is selected from the group consisting of indium tin oxide (ITO) and tin oxide (TO). In another illustrative embodiment of the method, the tuning fork further comprises a first tuning fork plate having a first surface and a second tuning fork plate having a second surface, wherein the first surface of the first tuning fork plate is placed over a portion of the electrode and touching the second surface of the second turning fork plate. In another illustrative embodiment of the method, the tuning fork and the substantially transparent conductive coating are substantially transparent; the method further includes but is not limited to visually inspecting the electrode embedded between a first and a second turning fork plate.

In a particular illustrative embodiment, a downhole method and apparatus are disclosed using a coated mechanical resonator, for example, a tuning fork to provide real-time direct measurements and estimates of the viscosity, density and dielectric constant of formation fluid or filtrate in a hydrocarbon producing well. The resonator is coated with a high temperature coating to adhering of materials to the resonator and introducing errors into measurements based on the resonator response. An illustrative embodiment provides valuable information regarding properties of fluids downhole regarding hydrocarbon deposits downhole so that drilling and production decisions can be made based on the properties of the fluids downhole. Millions of dollars must be invested in a drilling or production project. Thus, drillers are willing to pay significant sums of money for the information provided by an illustrative embodiment regarding properties of the fluids downhole from which to make drilling decisions.

Another particular illustrative embodiment additionally provides a method and apparatus for 1) monitoring cleanup from a leveling off of viscosity or density over time, 2) measuring or estimating bubble point for formation fluid or filtrate, 3) measuring or estimating dew point for formation fluid or filtrate, and 4) the onset of asphaltene precipitation. Another particular illustrative embodiment provides for intercalibration of a plurality of pressure gauges used to determine a pressure differential downhole. Each of these applications of an illustrative embodiment contributes to the commercial value of downhole monitoring while drilling and wire line tools. Thus, an illustrative embodiment provides direct viscosity and density measurement capability of a fluid downhole.

In one aspect of the invention, a downhole tool for determining the properties of a formation fluid sample is provided comprising a tool deployed in a well bore formed in an adjacent formation, the tool communicating and interacting with a quantity of downhole fluid, a mechanical resonator attached to the tool immersed in the fluid sample, a controller for actuating the mechanical resonator; and a monitor for receiving a response from the mechanical resonator to actuation of the mechanical resonator in the fluid. In another aspect of the invention a tool is provided further comprising a processor for determining a characteristic of a fluid sample from the response of the mechanical resonator. In another aspect of the invention a tool is provided wherein at least one of density, viscosity or dielectric constant are determined for a fluid downhole.

In another aspect of the invention a tool is provided wherein the characteristic of said fluid is used to determine the dew point of the fluid. In another illustrative embodiment a tool is provided wherein the characteristic of said fluid is used to determine the bubble point of a fluid. In another aspect of the invention a tool is provided wherein the characteristic of the fluid is used to monitor the cleanup over time while pumping.

In another aspect of the invention a tool is provided to determine the dew point of a formation fluid downhole. In another illustrative embodiment a tool is provided wherein the characteristic of the fluid is used to determine the onset of asphaltene precipitation. In another illustrative embodiment a tool is provided wherein the characteristics of the fluid being estimated are the NMR decay times T1 and T2, which are inversely correlated to viscosity, which is directly measured by the tuning fork. In another aspect of the invention a tool is provided further comprising a plurality of pressure gauges that are a known vertical separation distance apart in the fluid, wherein the mechanical resonator response is used to measure the density of the fluid to calculate the correct pressure difference for the amount of vertical separation. In another illustrative embodiment, the mechanical resonator is actuated electrically. The resonator is made of a piezoelectric material (such as quartz or lithium niobate) and has metallic electrodes embedded within the material. In another illustrative embodiment, the mechanical resonator is placed in a cavity outside the direct flow path to protect the tuning fork from damage from debris passing in the sample flow path.

In another illustrative embodiment, a hard organic or inorganic coating is placed on the flexural mechanical resonator (such as a tuning fork), over the conductive coating to reduce the effects of abrasion from sand particles suspended in the flowing fluid in which the flexural mechanical resonator is immersed. In another illustrative embodiment, an organic or inorganic coating having a low surface energy is placed on the flexural mechanical resonator over the conductive coating to reduce the adhesion of small solid particles and liquids to the surface of the resonator. Flexural mechanical resonators have been used in the laboratory for rapid characterization of large numbers of fluid samples. See L. F. Matsiev, Application of Flexural Mechanical Resonator to High Throughput Liquid Characterization, 2000 IEEE International Ultrasonics Symposium, Oct. 22-25, 2000 San Juan, Puerto Rico, incorporated herein by reference in its entirety; L. F. Matsiev, Application of Flexural Mechanical Resonator to High Throughput Liquid Characterization, 1999 IEEE International Ultrasonics Symposium, Oct. 17-20, Lake Tahoe, Nev., incorporated herein by reference in its entirety; L. F. Matsiev, Application of Flexural Mechanical Resonator to High Throughput Liquid Characterization, 1998 IEEE International Ultrasonics Symposium, Oct. 5-8, 1998, Sendai, Miyagi, Japan, incorporated herein by reference in its entirety.

An illustrative embodiment applies a conductive coating to flexural mechanical resonators such as tuning forks, benders, etc. to perform liquid characterization. Additional complex electrical impedance produced by a liquid environment to such resonators is also described. This additional impedance can be represented by the sum of two terms: one that is proportional to liquid density and a second one that is proportional to the square root the of viscosity density product. This impedance model is universally applicable to any resonator type that directly displaces liquid and has size much smaller than the acoustic wavelength in a liquid at its operation frequency. Using this model it is possible to separately extract liquid viscosity and density values from the flexural resonator frequency response.

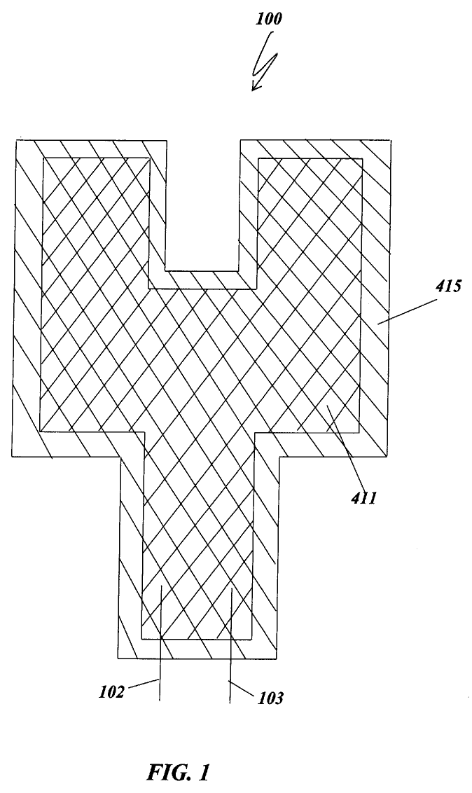

Turning now to FIG. 1, a front view of a particular illustrative embodiment is depicted. As shown in FIG. 1, a substantially transparent tuning fork 411 is coated with a substantially transparent conductive coating 415. Thus, electrodes 102 and 103 which are embedded in the turning fork are visible through the tuning fork. In a particular illustrative embodiment, the tuning fork is made of Lithium Niobate coated with TO. In another illustrative embodiment, the tuning fork is made of Lithium Niobate coated with ITO. In another illustrative embodiment, the tuning fork is made of Lithium Niobate coated with ZnO. In another illustrative embodiment, the tuning fork is made of Lithium Niobate coated with boron doped diamond. In another embodiment, the tuning fork is made of a substantially transparent piezoelectric material other than Lithium Niobate. In another particular the tuning fork is coated with a substantially transparent conductive material other than ITO or TO.

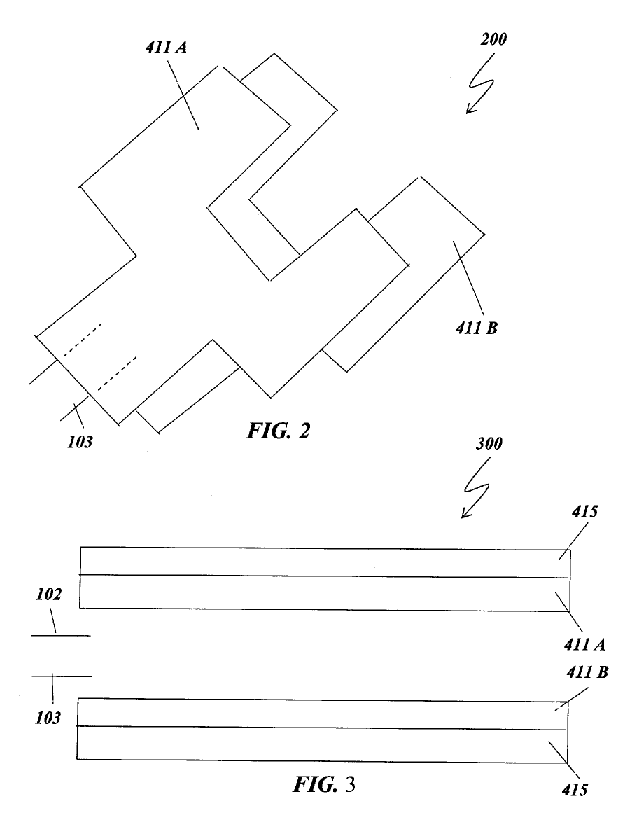

Turning now to FIG. 2, an exploded view of the tuning fork of FIG. 1 is depicted. In a particular illustrative embodiment, the turning fork 411 comprises a first tuning fork plate 411A and a second tuning fork plate 411B. Electrodes 102 and 103 are sandwiched between the first tuning fork plate 411A and the second tuning fork plate 411B. Turning now to FIG. 3, a side view of the tuning fork of FIG. 1 is depicted. A shown in FIG. 3, the first tuning fork plate 411a and the second tuning fork plate 411B are placed together to embed electrodes 102 and 103. The tuning fork plates are coated with a substantially transparent conductive coating 415 to induce an image current from an electrode(s) 102 and/or and 103.

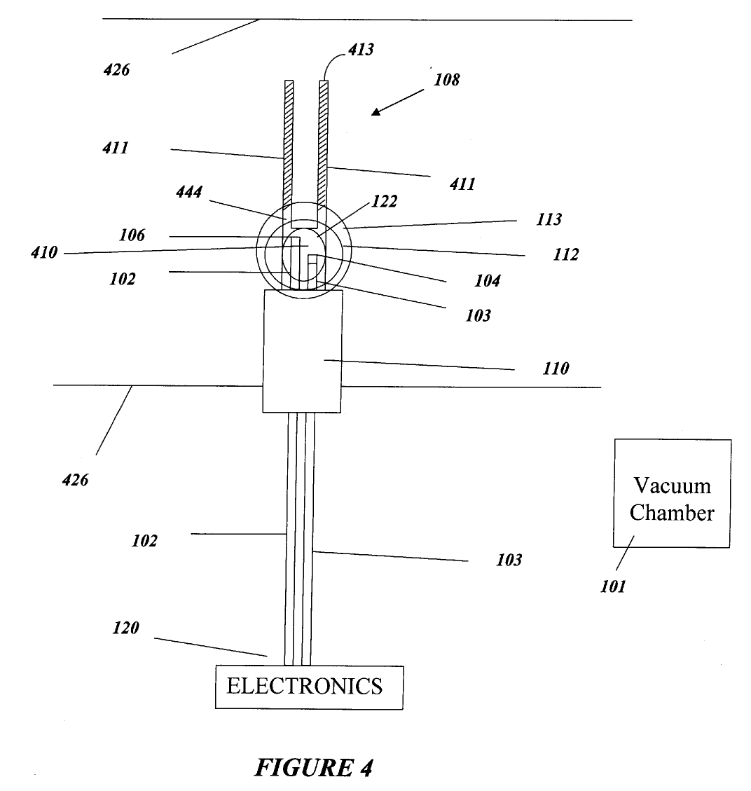

FIG. 4 illustrates a coated covering 413 for a tuning fork tines 411 disposed in a fluid flow path 426. In another illustrative embodiment, the coated covering 413 reduces adhesion of small solid particles or liquids to the tines 411. As shown in FIG. 4, in one particular illustrative embodiment electrical leads 102 and 103 run through a high pressure feed through 110. The electrical leads 102 and 103 attach to turning fork electrical connections 104 and 106. Electrical connections 104 and 106 attach to electrodes inside of turning fork 108. Insulator 112 can be provided to cover the bare electrical leads 102 and 103 and electrical connections 104 and 106. Insulator 112 deforms rather than cracks under downhole pressure so that the insulator does not crack under pressure cycling and allow brine or formation fluids to penetrate the cracks or short out the electrical connections or leads under the insulator.

The insulator 112 covers the tuning fork electrical connections 104, 106 to the tuning fork electrodes to the extent necessary to prevent electrical shorting of the electrical connections 104, 106 from conductive fluid. The conductive fluid can be water, formation fluid or some other conductive fluid. The insulator is also chemically resistant so that the volume of the insulator does not change significantly when exposed to formation fluid. In another particular embodiment an adhesion promoter such as a CF6-35 primer 122 is placed on the tuning fork before applying insulator 112 to facilitate adhesion of the insulator to the tuning fork. A rigid epoxy 113 can be placed over the insulator 112 or under the insulator 112 to strengthen the insulator 112. As discussed above, the insulator is pliable so that the vibration of the tuning fork tines 411 is substantially unencumbered.

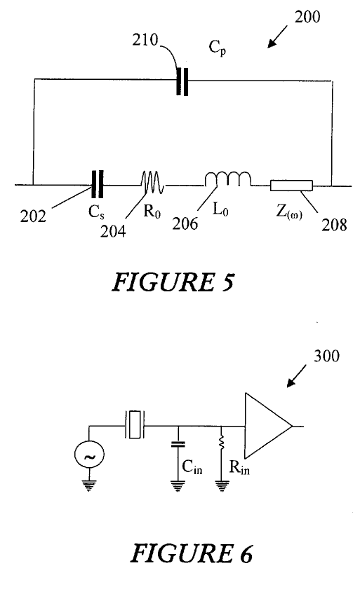

Piezoelectric resonators have been applied to the determination of mechanical properties of fluids for several decades. Piezoelectric resonators are simple harmonic oscillators that experience viscous damping when exposed to a fluid. A simple relationship between the electrical impedance of a piezoelectric resonator and the viscous damping caused by contact with a fluid has been derived using a simple one-dimensional mathematical model and is supported experimentally. It was found that the complex electrical impedance of a piezoelectric resonator in a fluid environment could be represented by an equivalent circuit 200 shown on FIG. 5.

There are a variety of ways to measure a piezoelectric resonator response in a liquid environment. In a laboratory environment an HP8751A network analyzer can be used to sweep frequencies and measure response when the resonator was exposed to a variety of organic solvents. The equivalent impedance of tuning forks is quite high, so the use of high impedance probe is recommended. In another particular embodiment in a downhole environment, a swept analyzer circuit is provided to sweep and analyze or measure the resonator response. In an illustrative embodiment an exciter circuit 300 is used to excite the resonator and is connected as shown on FIG. 6.

The equivalent circuit 200 from FIG. 5 describes the electrical impedance of a piezoelectric resonator with a modification for the additional impedance Zfluid 208 which represents the change in the resonators impedance caused by immersion of the resonator in a fluid. The capacitance Cp 210 represents the component of the electrical impedance resulting from stray electric fields. When a resonator that is not surrounded with a conductive coating is immersed in a fluid, these stray electric fields extend into the fluid, causing Cp to be dependent upon the electrical properties of the fluid such as conductivity and dielectric. Adding a conductive coating to the resonator confines the electric fields to the resonator, making Cp independent of the electrical properties of the surrounding fluid.

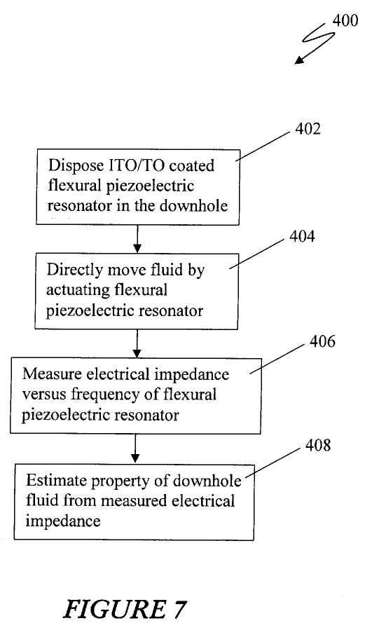

FIG. 7 is a flow chart depicting a method for estimating a property of a downhole fluid. The coated flexural piezoelectric resonator is disposed in the downhole fluid at block 402. The fluid is directly moved by the actuating flexural piezoelectric resonator at block 404. Electrical impedance versus frequency of flexural piezoelectric resonator is measured at block 406. The property of the downhole fluid from measured electrical impedance is estimated at block 408.

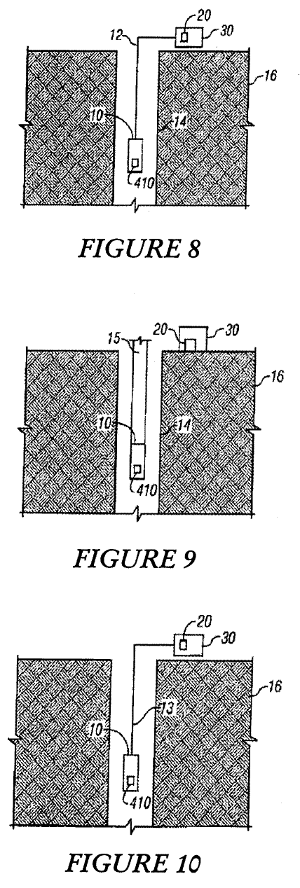

FIG. 8 is a schematic diagram of an illustrative embodiment deployed on a wire line in a downhole environment. As shown in FIG. 8, a downhole tool 10 containing a mechanical resonator 410 is deployed in a borehole 14. The borehole is formed in formation 16. Tool 10 is deployed via a wireline 12. Data from the tool 10 is communicated to the surface to a computer processor 20 with memory inside of a data acquisition system 30. FIG. 9 is a schematic diagram of an illustrative embodiment deployed on a drill string 15 in a monitoring while drilling environment. FIG. 10 is a schematic diagram of an illustrative embodiment deployed on a flexible tubing 13 in a downhole environment.

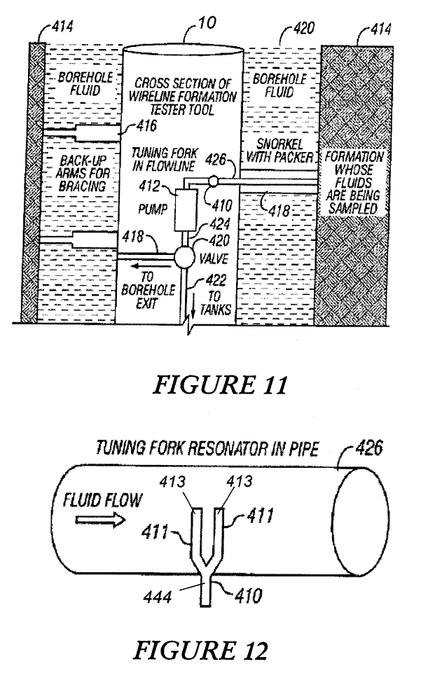

FIG. 11 is a schematic diagram of an illustrative embodiment as deployed in a wireline downhole environment showing a cross section of a wireline formation tester tool. As shown in FIG. 11, tool 10 is deployed in a borehole 420 filled with borehole fluid. The tool 10 is positioned in the borehole by backup support arms 416. A packer with a snorkel 418 contacts the borehole wall for extracting formation fluid from the formation 414. Tool 10 contains coated tuning fork 410 disposed in flow line 426. Any type of flexural mechanical oscillator is suitable for deployment in the tool of the present invention. The mechanical oscillator, shown in FIG. 11 as the coated tuning fork is excited by an electric current applied to its electrodes and monitored to determine density, and viscosity of the formation fluid. The electronics for exciting and monitoring the flexural mechanical resonator as shown in the Matsiev references are housed in the tool 10. Pump 412 pumps formation fluid from formation 414 into flow line is 426. Formation fluid travels through flow line 424 in into valve 420 which directs the formation fluid to line 422 to save the fluid in sample tanks or to line 418 where the formation fluid exits to the borehole. The tuning fork is excited and its response in the presence of a formation fluid sample is utilized to determine fluid density and viscosity while fluid is pumped by pump 412 or while the fluid is static, that is, when pump 412 is stopped.

FIG. 12 is a schematic diagram of an embodiment of the present invention illustrating a tuning fork 410 with tines 411 and conductive coating 413 deployed in a fluid flow pipe 426. A hard coating 444 can be added to turning fork 410 or other mechanical resonator to reduce the effects of abrasion.

In a second scenario of operation the fluid sample flowing in the tool is stopped from flowing by stopping the pump 412 while the mechanical resonator is immersed in the fluid and used to determine the density, viscosity and dielectric constant for the static fluid trapped in the tool. Samples are taken from the formation by pumping fluid from the formation into a sample cell. Filtrate from the borehole normally invades the formation and consequently is typically present in formation fluid when a sample is drawn from the formation. As formation fluid is pumped from the formation the amount of filtrate in the fluid pumped from the formation diminishes over time until the sample reaches its lowest level of contamination. This process of pumping to remove sample contamination is referred to as sample clean up. In a particular illustrative embodiment, the present invention indicates that a formation fluid sample clean up is complete when the viscosity or density has leveled off or become asymptotic within the resolution of the measurement of the tool for a period of twenty minutes to one hour. A density or viscosity measurement is also compared to a historical measure of viscosity or density for a particular formation and or depth in determining when a sample is cleaned up. That is, when a sample reaches a particular level or value for density and or viscosity in accordance with a historical value for viscosity and or density for the formation and depth the sample is determined to have been cleaned up to have reached a desired level of purity.

The bubble point pressure for a sample is indicated by that pressure at which the measured viscosity for formation fluid sample decreases abruptly. The dew point is indicated by an abrupt increase in viscosity of a formation fluid sample in a gaseous state. The asphaltene precipitation pressure is that pressure at which the viscosity decreases abruptly. The present invention also enables calibration of a plurality of pressure gauges at depth. Pressure gauges are typically very sensitive to changes but not accurate as to absolute pressure. That is, a pressure gauge can accurately determine a change of 0.1 PSI but not capable of accurately determining whether the pressure changed from 1000.0 to 1000.1 PSI or 1002.0 to 1002.1 PSI. That is, the precision is better than the accuracy in the pressure gauges. A particular illustrative embodiment enables determination of the absolute pressure difference between pressure gauges in a downhole tool from the density of the fluid measured by the present invention. Since the distance between the downhole pressure gauges is known, one can determine what the pressure difference or offset should be between the pressure gauges at a particular pressure and temperature. This calibration value or offset is added to or subtracted from the two pressure gauge readings.

An illustrative embodiment can utilize the Matsiev calculations to calculate density and viscosity. A particular illustrative embodiment provides a chemometric equation derived from a training set of known properties to estimate formation fluid parameters. Another illustrative embodiment provides a neural network derived from a training set of known properties to estimate formation fluid parameters. For example, from a measured viscosity, a chemometric equation can be used to estimate NMR properties T.sub.1 and T.sub.2 for a sample to improve an NMR measurement made independently in the tool. The chemometric equation can be derived from a training set of samples for which the viscosity and NMR T.sub.1 and T.sub.2 are known. Any soft modeling technique may be applicable with an illustrative embodiment.

Another particular illustrative embodiment can be utilized to provide density, viscosity, dielectric coefficient and other measured or derived information available from the tool of the present invention to a processor or intelligent completion system (ICS) at the surface. The ICS is a system for the remote, intervention less actuation of downhole completion equipment has been developed to support the ongoing need for operators to lower costs and increase or preserve the value of the reservoir, which are particularly important in offshore environments where well intervention costs are significantly higher than those performed onshore.

An operator, located at the surface and having access to over ride the processor/ICS 30 may make his own decisions and issue commands concerning well completion based on the measurements provided by the present invention. A particular illustrative embodiment may also provide data during production logging to determine the nature of fluid coming through a perforation in the well bore, for example, the water and oil ratio. As shown in FIG. 4, the coating 413 may coat only the tines 411 or may coat the entire tuning fork 410 and the tines 411. In another illustrative embodiment of the invention, a hard or inorganic coating 444 can be placed on the flexural mechanical resonator 410 (such as a tuning fork) and tines 411 to reduce the effects of abrasion from sand particles suspended in the flowing fluid in which the flexural mechanical resonator is immersed. The coating should be hard enough to protect against sand abrasion. For example, the coating should be harder than glass (sand).

The foregoing example is for purposes of example only and is not intended to limit the scope of the invention which is defined by the following claims.

What is claimed is:

1. An apparatus for estimating a property of a fluid downhole comprising:
a piezoelectric resonator disposed in the fluid downhole;
an electrode embedded in the piezoelectric resonator; and
a substantially transparent electrically-conductive coating covering the piezoelectric resonator.

2. The apparatus of claim 1, further comprising:
a controller in electrical communication with the electrode that actuates the piezoelectric resonator at a frequency.

3. The apparatus of claim 1, wherein the substantially transparent conductive coating is made of ceramic.

4. The apparatus of claim 1, wherein the substantially transparent conductive coating is selected from the group consisting of indium tin oxide (ITO), tin oxide (TO) zinc oxide and boron doped diamond.

5. The apparatus of claim 1, wherein the tuning fork further comprises a first tuning fork plate having a first surface and a second tuning fork plate having a second surface, wherein the first surface of the first tuning fork plate is placed over a portion of the electrode and touching the second surface of the second turning fork plate.

6. The apparatus of claim 1, wherein the flexural mechanical resonator is made of Lithium Niobate.

7. The apparatus of claim 1, wherein the tuning fork and the substantially transparent conductive coating are substantially transparent thereby enabling visual inspection of the electrode embedded between a first and a second turning fork plate.

8. A downhole tool for estimating a property of a fluid downhole comprising:
a piezoelectric resonator disposed in the fluid downhole;
an electrode embedded in the piezoelectric resonator; and
a substantially transparent conductive coating covering the piezoelectric resonator.

9. The downhole tool of claim 8, further comprising:
a controller in electrical communication with the electrode that actuates the piezoelectric resonator at a frequency.

10. The downhole tool of claim 8, wherein the substantially transparent conductive coating is made of ceramic.

11. The downhole tool of claim 8, wherein the substantially transparent conductive coating is selected from the group consisting of indium tin oxide (ITO) and tin oxide (TO).

12. The downhole tool of claim 9, wherein the tuning fork further comprises a first tuning fork plate having a first surface and a second tuning fork plate having a second surface, wherein the first surface of the first tuning fork plate is placed over a portion of the electrode and touching the second surface of the second turning fork plate.

13. The downhole tool of claim 8, wherein the piezoelectric resonator is made of Lithium Niobate.

14. The downhole tool of claim 8, wherein the tuning fork and the substantially transparent conductive coating are substantially transparent thereby enabling visual inspection of the electrode embedded between a first and a second turning fork plate.

15. A method for estimating a property of a fluid downhole, the method comprising:
Embedding an electrode in piezoelectric resonator;
Coating the piezoelectric resonator with a substantially transparent conductive coating; and
Disposing a piezoelectric resonator disposed in the fluid downhole;

16. The method of claim 15, the method further comprising:
Actuating the piezoelectric resonator at a frequency with a controller in electrical communication with the electrode of the piezoelectric resonator.

17. The method of claim 15, wherein the substantially transparent conductive coating is made of ceramic.

18. The method of claim 15, wherein the substantially transparent conductive coating is selected from the group consisting of indium tin oxide (ITO), tin oxide (TO), zinc oxide and boron doped diamond.

19. The method of claim 15, wherein the tuning fork further comprises a first tuning fork plate having a first surface and a second tuning fork plate having a second surface, wherein the first surface of the first tuning fork plate is placed over a portion of the electrode and touching the second surface of the second turning fork plate.

20. The method of claim 1, wherein the tuning fork and the substantially transparent conductive coating are substantially transparent; the method further comprising: visually inspecting the electrode embedded between a first and a second turning fork plate.
